(19) United States
(12) Patent Application Publication
(10) Pub. No.: US 2008/0030051 A1
(43) Pub. Date: Feb. 7, 2008

(54) Attachment structure of guide frame in sunroof apparatus

(76) Inventors: Hiroyuki Tsukamoto, Tochigi (JP); Kazutaka Sugimoto, Tochigi (JP); Masaharu Ohnishi, Saitama (JP); Keisuke Takayama, Saitama (JP)

Correspondence Address: ARENT FOX LLP, 1050 CONNECTICUT AVENUE, N.W., SUITE 400, WASHINGTON, DC, 20036, US

(21) Appl. No.: 11/878,442

(22) Filed: Jul. 24, 2007

(30) Foreign Application Priority Data
Aug. 4, 2006 (JP) 2006-213054

(51) Int. Cl. B60J 7/043

(52) U.S. Cl. 296/216.04

(57) ABSTRACT

In a sunroof apparatus including a roof panel attached to an opening of a fixed roof of a vehicle; a slider which is attached to the roof panel, slides in a vehicle front-to-rear direction, and thereby opens and closes the roof panel in the vehicle front-to-rear direction; and a guide frame having a guide frame rail for guiding the slider to slide on the guide frame rail, an attachment structure of the guide frame in the sunroof apparatus includes a bolt configured to join the guide frame and a vehicle body and provided in the guide frame rail or on an extension thereof.

### BACKGROUND OF THE INVENTION

1. Field of the Invention

The present invention relates to a sunroof apparatus of a vehicle.

2. Description of the Related Art

As a sunroof apparatus of a vehicle, as shown in FIG. 6, there is a sunroof apparatus 100 including a roof panel 4 attached to an opening 3 of a fixed roof 2; a slider (not shown) for opening and closing the panel 4 in a vehicle front-to-rear direction; and guide frames 5, 5 having a guide frame rail for guiding the slider sliding (for example, see paragraphs 0016 to 0020 and FIGS. 1 and 3 in Japanese Patent Laid-Open Publication No. 2005-41345).

In such the sunroof apparatus 100 a pair of the guide frames 5, 5, which are symmetric with respect to left and right sides and are extended in the vehicle front-to-rear direction, are attached to lower portions of both side edges of the opening 3, and in each of the guide frames 5 a guide frame rail for accommodating the slider is extendedly provided in the vehicle front-to-rear direction. Then by a cable (not shown) performing a push-pull operation, the slider slides on the guide frame rail, and thereby the roof panel 4 is configured to be opened and closed.

Furthermore, a front frame 6 for joining front ends of the guide frames 5, 5 with each other is provided at a lower portion of a front edge of the opening 3; a rear frame 7 for joining rear ends of the guide frames 5, 5 with each other is provided at a lower portion of a rear edge of the opening 3.

In each guide frame 5, as shown in FIG. 7, a guide frame rail 5b is extendedly provided inside the vehicle in the vehicle front-to-rear direction; a flange portion 5e is extendedly provided at a vehicle outside in the vehicle front-to-rear direction. Then a bolt is inserted in an attachment hole 5f formed in the flange portion 5e and is screwed together with a vehicle body VB, and thereby the guide frame 5 and the vehicle body VB are joined.

Furthermore, in the guide frame 5 shown in FIG. 7, the guide frame rail 5b passes through an upper face of the front frame 6 and protrudes toward the vehicle front, and this protruded portion is attached to the front frame 6 through a bracket 6a. Furthermore, both side ends of the front frame 6 are attached to the flange portion 5e of the guide frame 5.

In the sunroof apparatus 100, because the slider for supporting the roof panel 4 (see FIG. 6) is accommodated in the guide frame rail 5b of the guide frame 5, the self weight of the roof panel 4 is adapted to act on the guide frame rail 5b. In the guide frame 5, because the flange portion 5e at the vehicle outside is attached to the vehicle body VB, the frame 5 is in a state of one-side support; therefore, a rigidity of the guide frame 5 is weak and a bending easily occurs in the frame 5 due to the self weight of the roof panel 4 acting on the guide frame rail 5b inside the vehicle. Accordingly, in the conventional sunroof apparatus 100, there is a problem that the roof panel 4 vibrates during running of the vehicle and a noise is generated.

Consequently, there is a need for an attachment structure of a guide frame in a sunroof apparatus which the structure can increase a rigidity of the frame for guiding opening and closing of a roof panel of the apparatus.

### SUMMARY OF THE INVENTION

The present invention relates to an attachment structure of a guide frame in a sunroof apparatus, and the sunroof apparatus comprises: a roof panel attached to an opening of a fixed roof of a vehicle; a slider attached to the roof panel and sliding in the vehicle front-to-rear direction and thereby opening and closing the roof panel in the vehicle front-to-rear direction; and a guide frame having a guide frame rail for guiding the slider sliding, wherein a joining member configured to join the guide frame and a vehicle body is provided in the guide frame rail or on an extension thereof.

In accordance with the configuration, because the joining member configured to join the guide frame and the vehicle body is provided in the guide frame rail or on the extension thereof, and in the guide frame a support place is provided near a portion where the self weight of the roof panel acts, the rigidity of the guide frame can be increased. Thus the guide frame becomes difficult to bend and the roof panel becomes difficult to vibrate, a noise generation due to the vibration of the roof panel can be prevented.

In addition, the joining member is not necessarily on the guide frame rail or on the extension thereof, and may be provided at any area including the frame rail or the extension.

In the attachment structure of the guide frame in the sunroof apparatus, the joining member is a frame extendedly provided in a vehicle width direction, wherein the frame is attached to the guide frame rail of the guide frame and the vehicle body.

Thus the joining member is configured by the frame extendedly provided in the vehicle width direction, and thereby the rigidity of the guide frame can be increased by using an existing frame; thus a number of components can be reduced in the attachment structure of the guide frame, and an attachment work thereof can be facilitated.

In the attachment structure of the guide frame in the sunroof apparatus, the joining member is a bracket of which one side is attached to the guide frame rail of the guide frame and of which the other side is attached to the vehicle body.

In accordance with the configuration, in forming the bracket it is associated with a form of the vehicle body, thereby the joining member can be provided in the guide frame rail or on the extension thereof, and thus the rigidity of the guide frame can be increased.

In accordance with the attachment structure of the guide frame in the sunroof apparatus of the present invention, because the rigidity of the guide frame can be enhanced for guiding the opening and closing of the roof panel, the guide frame becomes difficult to bend, and the roof panel becomes difficult to vibrate, a noise generation due to the vibration of the roof panel can be prevented and the quality of the sunroof apparatus can be enhanced.

### BRIEF DESCRIPTION OF THE DRAWINGS

FIG. 1 is a plan view showing a sunroof apparatus of a first embodiment of the present invention.

FIGS. 2A, 2B, and 2C are drawings showing opening and closing operations of a roof panel in the sunroof apparatus of the first embodiment;

FIG. 2A is a side view of a state of the roof panel being fully closed; FIG. 2B is a side view of a state of the roof panel being tilted up; and FIG. 2C is a side view of a state of the roof panel being sliding rearward.

FIG. 3 is a drawing showing the sunroof apparatus of the first embodiment, and an enlarged perspective view of a portion A in FIG. 1.

FIG. 4 is an enlarged perspective view showing a sunroof apparatus of a second embodiment of the present invention.

FIG. 5 is an enlarged perspective view showing a sunroof apparatus of a third embodiment of the present invention.

FIG. 6 is a plan view showing a conventional sunroof apparatus.

FIG. 7 is a drawing showing the conventional sunroof apparatus, and an enlarged perspective view of a portion A′ in FIG. 6.

### BEST MODE FOR CARRYING OUT THE INVENTION

Here will be described embodiments of the present invention in detail, referring to drawings as needed. In a description of each embodiment a same symbol will denote a same element, and a duplicate description thereof will be omitted.

### First Embodiment

Firstly, a first embodiment of the present invention will be described in detail, referring to drawings as needed. In the first embodiment, as an example will be described a case of the present invention being applied to a roof of a vehicle (automobile). Then in a description below, after a description of a general configuration of a sunroof apparatus, an attachment structure of a guide frame will be described.

[Configuration of Sunroof Apparatus]

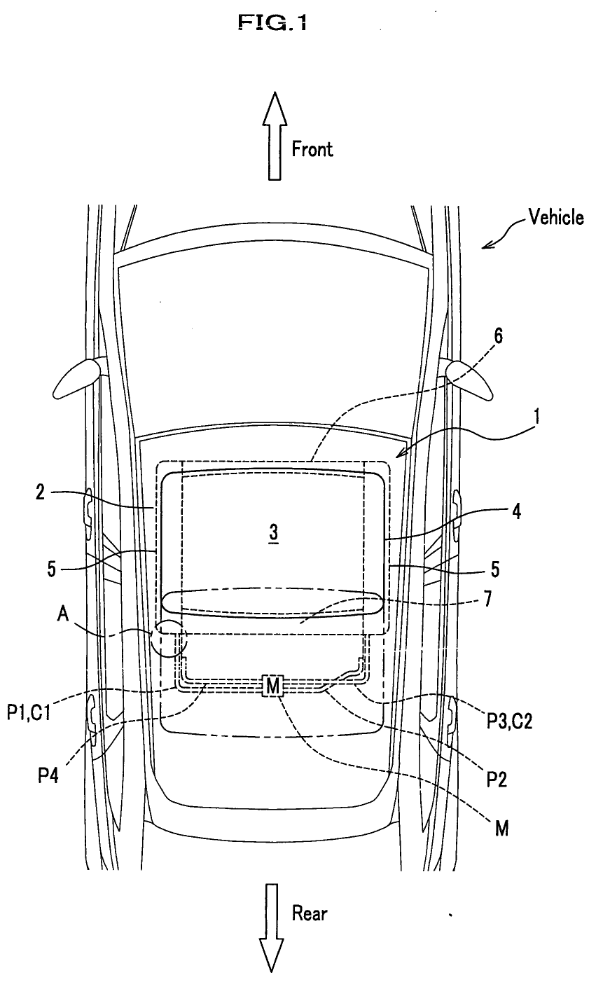

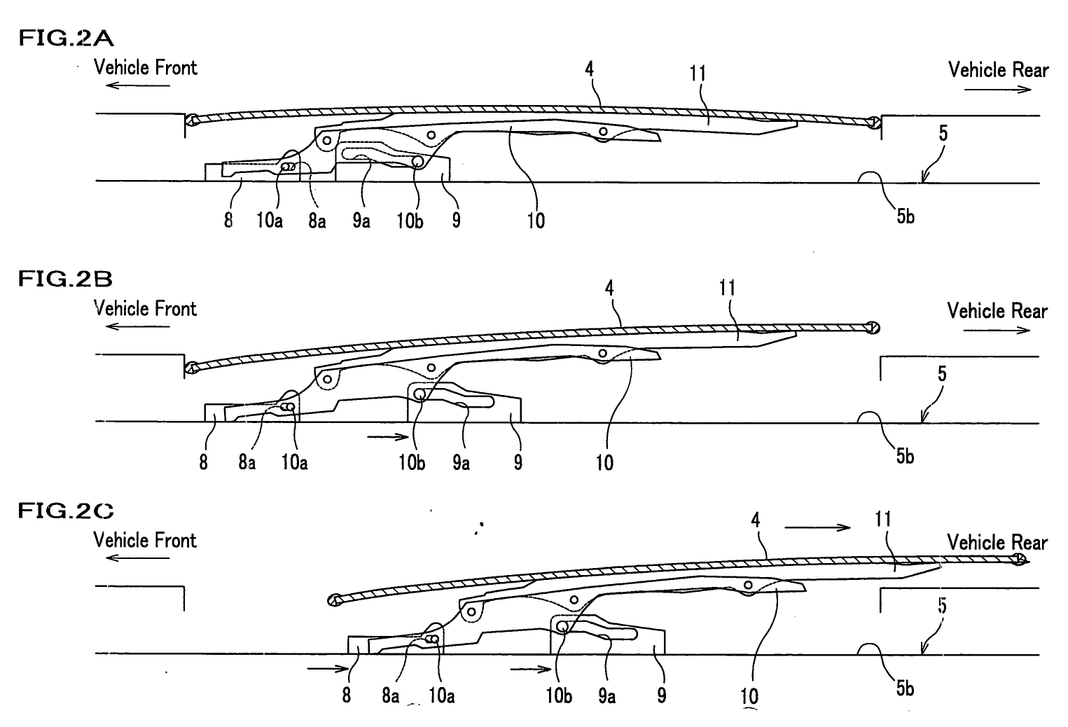

As shown in FIG. 1, a sunroof apparatus 1 of the first embodiment is an outer slide type and comprises: a roof panel 4 loaded on an opening 3 of a fixed roof 2 of a vehicle; sliders 8, 9 (see FIGS. 2A, 2B, and 2C) attached to the roof panel 4 and sliding in the vehicle front-to-rear direction and thereby opening and closing the roof panel 4 in the vehicle front-to-rear direction; cables C1, C2 joined to the slider and opening and closing the roof panel 4 by a push-pull operation; and guide frames 5, 5 having a guide frame rail 5b (see FIGS. 2A, 2B, and 2C) for guiding the slider sliding.

[Configuration of Roof Panel]

The roof panel 4 shown in FIG. 1 is a panel made of, for example, glass. The roof panel 4 is configured: in a case of the panel 4 being closed, to close the opening 3 of the fixed roof 2; in a case of the panel 4 being opened, to be tilted up by a tilt and slide mechanism described later, to move toward a vehicle rear, and to thereby come above the fixed roof 2 and be opened.

In addition, to both side edges of the roof panel 4 are respectively joined the cables C1, C2 of a pair through the tilt and slide mechanism; the cables C1, C2 synchronously perform push-pull operations, and thereby the roof panel 4 is configured to be opened and closed while the panel 4 keeps a stable position.

[Configuration of Tilt and Slide Mechanism]

In the sunroof apparatus 1 shown in FIG. 1 the tilt and slide mechanism including a tilt mechanism and slide mechanism of the roof panel 4 is accommodated in each of the guide frames 5, 5. The tilt and slide mechanism comprises, as shown in FIG. 2A, the sliders 8, 9 (front slider 8 and rear slider 9) sliding in the vehicle front-to-rear direction in the guide frame rail 5b formed in each guide frame 5; and a panel support stay 10 of which an upper portion is attached to the roof panel 4 and of which a lower portion is attached to the front slider 8 and the rear slider 9. Thus the roof panel 4 is supported by the front slider 8 and the rear slider 9.

In addition, because each tilt and slide mechanism accommodated in each guide frame 5 is an identical configuration, in the first embodiment one tilt and slide mechanism will be described and the description of the other will be omitted.

In the front slider 8 and the rear slider 9 are respectively formed cam holes 8a, 9a; in the panel support stay 10 are formed engagement pins 10a, 11a for respectively engaging with the cam holes 8a, 9a. Furthermore, the panel support stay 10 is attached to a lower face of a side edge of the roof panel 4 through a panel support bracket 11.

To the rear slider 9 is joined one end of the cable C1 or C2 (see FIG. 1) for performing a push-pull operation, and is configured to slide in the vehicle front-to-rear direction along the guide frame rail 5b by the push-pull operation of the cable C1 (C2). Furthermore, in conjunction with the sliding of the rear slider 9, the panel support stay 10 and the front slider 8 are also adapted to slide in the vehicle front-to-rear direction.

Next will be described opening and closing operations of the roof panel 4 by the tilt and slide mechanisms. In FIG. 2A the roof panel 4 is in a state of being kept fully closed, and the front slider 8 and the rear slider 9 are respectively disposed at most forward positions. From this state, if the rear slider 9 slides slightly toward the vehicle rear by the cable C1 (C2), the engagement pins 10a, 10b of the panel support stay 10 move, as shown in FIG. 2B, within the cam holes 8a, 9a of the front slider 8 and the rear slider 9, thereby a rear side of the stay 10 is raised and tilted, and the roof panel 4 is lifted up.

Moreover, from this state, if the rear slider 9 slides toward the vehicle rear, in conjunction with the slider 9 the front slider 8 joined to the rear slider 9 through the panel support stay 10 also slides, as shown in FIG. 2C, toward the vehicle rear, the rear side of the roof panel 4 comes above the fixed roof 2, and the roof panel 4 becomes in a state of being opened.

[Configuration of Cable]

The cables C1, C2 shown in FIG. 1 are respectively joined to the rear sliders 9, 9 (see FIGS. 2A, 2B, and 2C) of the tilt and slide mechanisms, synchronously perform push-pull operations, and thereby are configured to open and close the roof panel 4.

The cables C1, C2 are inserted in a drive motor unit M installed behind the opening 3, respectively engage with pinion gears (not shown) in the drive motor unit M, and thereby are configured to perform the push-pull drive.

Furthermore, in the cable C1 a route (drive route) on a side joined to one side edge (left in FIG. 1) of the roof panel 4 is formed in a guide pipe P1 on a left side of the drive motor unit M; a route (idling route) opposite to the drive route is formed in a guide pipe P2 for guiding a remaining length of the cable C1. Similarly, in the cable C2 a route (drive route) on a side joined to the other side edge (right in FIG. 1) of the roof panel 4 is formed in a guide pipe P3 on the right side of the drive motor unit M; a route (idling route) opposite to the drive route is formed in a guide pipe P4. The guide pipes P1, P2, P3, and P4 are formed, for example, of any one of an aluminum pipe and a steel pipe.

[Configuration of Guide Frame]

In the sunroof apparatus 1 of the first embodiment, as shown in FIG. 1, a pair of the left-right symmetric guide frames 5, 5 extendedly provided in the vehicle front-to-rear direction are attached to the lower portions of the both side edges of the opening 3. Furthermore, the front frame 6 for joining the front ends of the guide frames 5, 5 with each other is provided at the lower portion of the front edge of the opening 3; the rear frame 7 for joining the rear ends of the guide frames 5; 5 with each other is provided at the lower portion of the rear edge of the opening 3.

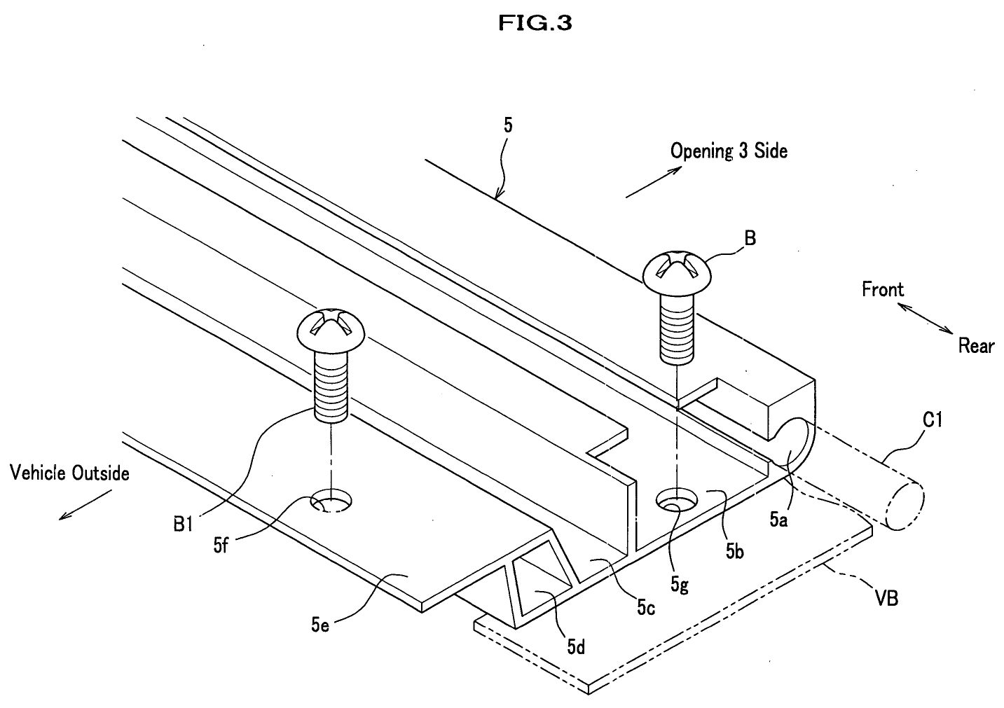

Each of the guide frames 5, 5 is formed, for example, with an extruded material of an aluminum alloy, and as shown in FIG. 3, sequentially from the near side of the opening 3 to the outside of the vehicle are extendedly in the vehicle front-to-rear direction provided an insertion groove 5a where the cable C1 is inserted; the guide frame rail 5b for guiding the sliding of the front slider 8 and rear slider 9 (see FIG. 2) of the tilt and slide mechanism; and a drain 5c for draining such rain water. Furthermore, a hollow closed section portion 5d is extendedly provided outside the vehicle in the vehicle front-to-rear direction, and thereby the rigidity of the guide frame 5 is increased. Moreover, on a side face of the guide frame 5 outside the vehicle, the horizontal flange portion 5e is extendedly provided along the upper edge.

In addition, a stopper is fitted in the end of the guide frame rail 5b in order to regulate the rearward movement of the rear slider 9 (see FIG. 2). The stopper is not shown in FIG. 3 in order to make the configuration of the guide frame 5 to be easily seen.

In the guide frame 5, because the front slider 8 and the rear slider 9 (see FIGS. 2A, 2B, and 2C) for supporting the roof panel 4 (see FIG. 1) are accommodated in the guide frame rail 5b, the self weight of the roof panel 4 are adapted to act on the guide frame rail 5b at the opening 3 side.

[Attachment Structure of Guide Frame]

Next will be described an attachment structure of the guide frame 5 in the first embodiment.

In addition, in the sunroof apparatus 1 of the first embodiment, as shown in FIG. 1, because the attachment structure of each of the guide frames 5, 5 is configured to be left-right symmetric, hereafter the attachment structure of the guide frame 5 disposed on the left side toward the vehicle front will be described, and that of the frame 5 disposed on the right side will not be described.

In the first embodiment, as shown in FIG. 3, the rear end of the guide frame rail 5b of the guide frame 5 is attached to the vehicle body VB by a bolt B, and the flange portion 5e of the frame 5 is also attached to the vehicle body VB by the bolt B; thereby the frame 5 and the vehicle body VB are joined.

Firstly, a plurality of attachment holes are bored through the flange portion 5e 5f at a predetermined interval in the vehicle front-to-rear direction. The attachment holes 5f are disposed so as to respectively communicate with a plurality of screw holes formed in the vehicle body VB, and a bolt B1 inserted in each of the attachment holes 5f from above the flange portion 5e is screwed in one of the screw holes; thus the flange portion 5e is adapted to be attached to the vehicle body VB.

Furthermore, an attachment hole 5g is bored through a bottom portion of a rear end of the guide frame rail 5b. The attachment hole 5g is provided so as to communicate with the screw hole formed in the vehicle body VB, and the bolt B inserted in the attachment hole g from above the guide frame rail 5b is screwed in one of the screw holes; thus the rear end of the guide frame rail 5b is adapted to be attached to the vehicle body VB.

Thus in the attachment structure of the guide frame 5 in the first embodiment, the bolt B (joining member) for joining the guide frame 5 and the vehicle body VB is provided in the guide frame rail 5b.

[Action and Effect of Attachment Structure of Guide Frame]

In accordance with the attachment structure of the guide frame 5, the bolt B for joining the guide frame 5 and the vehicle body VB is provided in the guide frame rail 5b; in the guide frame 5 the support place is provided near a portion to which the self weight of the roof panel 4 (see FIG. 1) is applied; and therefore, the rigidity of the guide frame 5 can be increased. Thus the guide frame 5 becomes difficult to bend, and the roof panel 4 becomes difficult to vibrate; therefore, a noise due to the vibration of the panel 4 can be prevented and the quality of the sunroof apparatus 1 can be enhanced.

### Modification Example

Thus although the first embodiment of the present invention has been described, the invention is not limited to the embodiment; the design thereof can be changed within the spirit and scope of the invention. For example, in the first embodiment, as shown in FIG. 3, although the bolt B is used as the joining member for joining the guide frame 5 and the vehicle body VB, the configuration of the joining member is not limited thereto; various known fixation means can be used, and for example, a fit-in pin fitted in a hole portion of the vehicle body VB can also be used.

Furthermore, in the first embodiment, although the configuration of attaching the rear end of the guide frame rail 5b to the vehicle body VB has been described as shown in FIG. 3, similarly any one of the front end and middle portion of the guide frame rail 5b can be attached to the vehicle body VB. Thus by increasing the attachment portions of the guide frame 5 to the vehicle body VB, the rigidity of the frame 5 can be surely increased. Furthermore, if the guide frame 5 can be attached with a sufficient strength to the vehicle body VB by the bolt B (joining member) provided in the guide frame rail 5b, it is not necessary to attach the flange portion 5e to the vehicle body VB.

Furthermore, in the guide frame 5 of the first embodiment, although the insertion groove 5a, the guide frame rail 5b, the drain 5c, the hollow closed section portion 5d, and the flange portion 5e are formed, at least the bottom 5b may be formed; the frame 5 is not limited to the presence or absence of the others and the form thereof.

Furthermore, in the first embodiment, although the sunroof apparatus 1 of the outer slide type is described as an example as shown in FIG. 1 and FIGS. 2A, 2B, and 2C, the present invention is also applicable to a sunroof apparatus of an inner slide type configured to be opened in a state of the roof panel 4 being tilted down.

### Second Embodiment

Next will be described a second embodiment of the present invention. The section embodiment is a configuration approximately similar to that of the first embodiment; the configuration of the joining member is different.

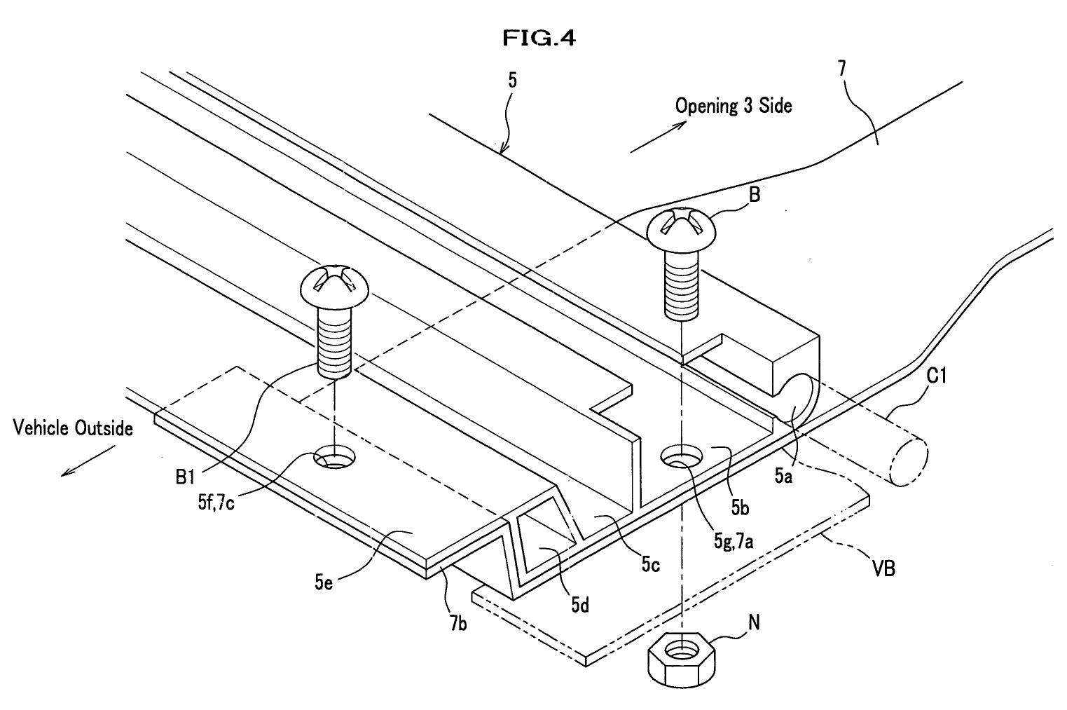

In the second embodiment, as shown in FIG. 4, as the joining member for joining the guide frame 5 and the vehicle body VB is used the rear frame 7 extendedly provided in a vehicle width direction.

An end of the rear frame 7 on the vehicle outside passes under the rear portion of the guide frame 5, and thus the frame 5 is placed on the frame 7. Furthermore, the end of the rear frame 7 at the vehicle outside is formed along the lower face of the rear portion of the guide frame 5, and a fixation hole 7a is bored through the end of the frame 7 which the hole 7a communicates with the attachment hole 5g formed at the rear end of the guide frame rail 5b.

Then on underside of the rear frame 7, a nut N is screwed together with the bolt B inserted in the attachment holes 5g, 7a from above the guide frame rail 5b; thereby the rear end of the bottom 5b is adapted to be attached to the frame 7.

Moreover, at the end of the rear frame 7 outside the vehicle is formed an attachment portion 7b attached to the flange portion 5e of the guide frame 5 and the vehicle body VB. The attachment portion 7b is horizontally formed along the lower face of the flange portion 5e and communicates with the attachment hole 5f of the portion 5e; and an attachment hole 7c is bored through the portion 7b for communication with a screw hole formed in the vehicle body VB.

Then the bolt B1 inserted in the attachment holes 5f, 7c from above the flange portion 5e is screwed in the screw hole; thereby the flange portion 5e and the rear frame 7 are adapted to be attached to the vehicle body VB.

Thus in the second embodiment as the joining member for joining the guide frame 5 to the vehicle body VB is used the rear frame 7 provided at an area including the guide frame rail 5b, and thus the rear end of the bottom 5b is attached to the vehicle body VB by the frame 7. Thus because in the guide frame 5 the support places are provided near a portion where the self weight of the roof panel 4 (see FIG. 1) acts, the rigidity of the frame 5 can be increased and a noise generated by the vibration of the panel 4 can be prevented.

Furthermore, because the rigidity of the frame 5 can be increased by using the existing rear frame 7, the number of components can be reduced in the attachment structure of the guide frame 5 and to facilitate the attachment work thereof.

In addition, various modified examples are applicable to the second embodiment as well as the first embodiment. For example, in the second embodiment, although the case of attaching the rear end of the guide frame rail 5b to the vehicle body VB has been described, the front end of the bottom 5b can also be attached to the vehicle body VB. In this case the front frame 6 (see FIG. 1) provided at an area including the guide frame rail 5b can be used as the joining member, and thus the front end of the bottom 5b can be attached to the vehicle body VB by the front frame 6.

### Third Embodiment

Next will be described a third embodiment of the present invention. The third embodiment is a configuration approximately similar to that of the first embodiment, and the configuration of the joining member is different.

In the third embodiment as the joining member for joining the guide frame 5 and the vehicle body VB is used a joining bracket 20, of which one side is attached to the rear end of the guide frame rail 5b and of which the other side is attached to the vehicle body VB. The joining bracket 20 is a rectangular plate form member in plan view, and a longitudinal side is disposed in the vehicle front-to-rear direction. Furthermore, two attachment holes 20a, 20b are bored through the joining bracket 20 at a predetermined interval in the longitudinal direction.

The front attachment hole 20a communicates with the attachment hole 5g formed at the rear end of the guide frame rail 5b, and the nut N is screwed together with the bolt B inserted in the attachment holes 20a, 5g from above the joining bracket 20; thereby the bracket 20 is adapted to be attached to the rear end of the bottom 5b.

Furthermore, the rear attachment hole 20b communicates with a screw hole formed in the vehicle body VB on the extension of the guide frame rail 5b, and the rear bolt B inserted in the attachment hole 20b from above the joining bracket 20 is screwed in the screw hole of the vehicle body VB; thereby the bracket 20 is adapted to be attached to the vehicle body VB.

Thus in the third embodiment as the joining member for joining the guide frame 5 to the vehicle body VB is used the joining bracket 20 attached to the guide frame rail 5b of the frame 5 and thus the bracket 20 is attached to the vehicle body VB on the extension of the bottom 5b. Thus because in the guide frame 5 the support places are provided near a portion where the self weight of the roof panel 4 (see FIG. 1) acts, the rigidity of the panel 4 can be increased and a noise due to the vibration of the panel 4 can be prevented.

Furthermore, in forming the joining bracket 20, the bracket 20 is associated with a form of the vehicle body VB; thereby the rear and of the guide frame rail 5b can be attached to the vehicle body VB without being influenced by the form of the vehicle body VB, and the rigidity of the guide frame 5 can be increased.

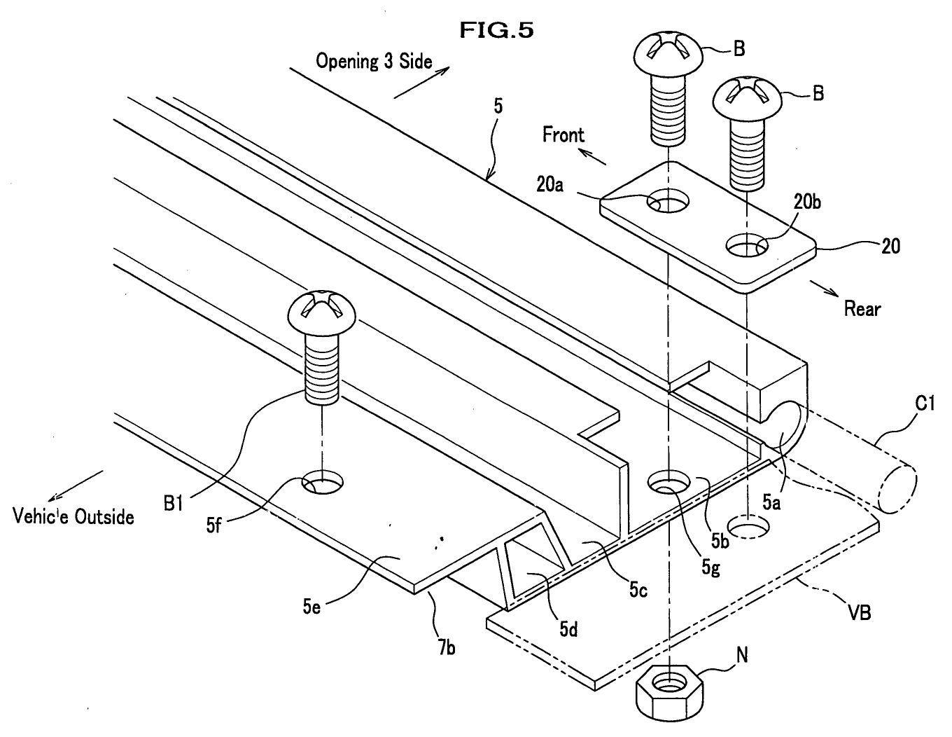

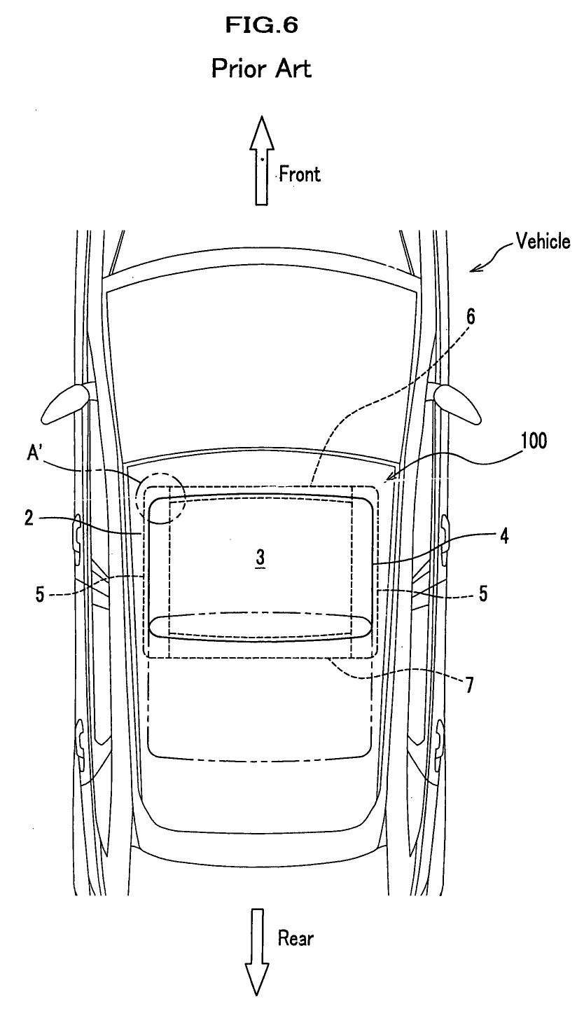

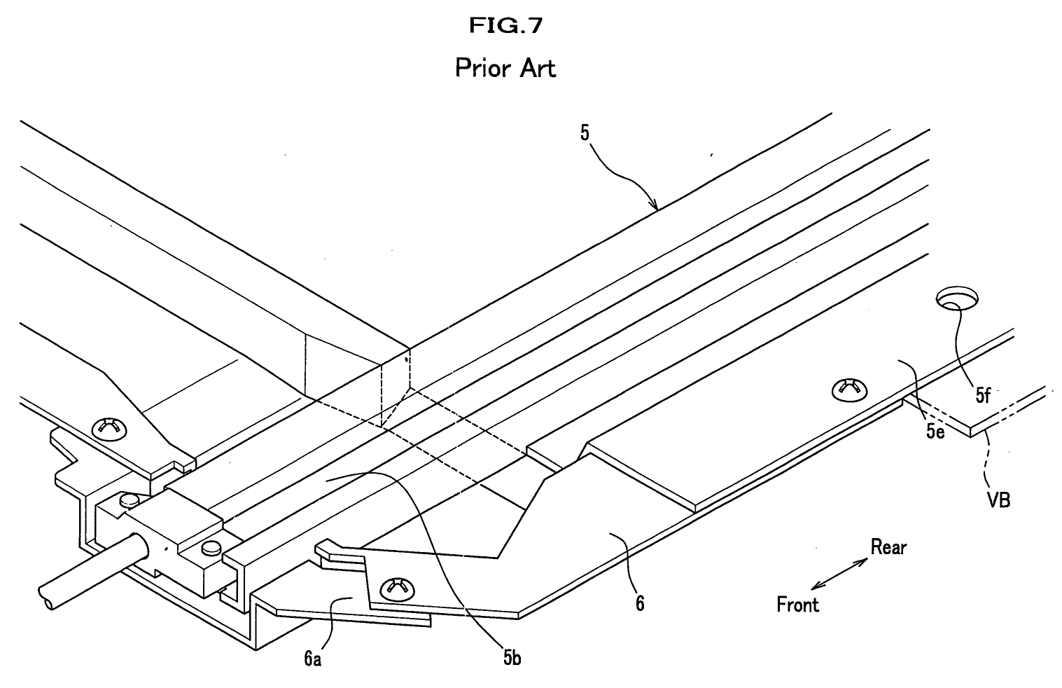

In addition, various variation examples are applicable to the third embodiment as well as the first embodiment. For example, in the third embodiment, although the joining bracket 20 is extendedly provided on the extension of the guide frame rail 5b as shown in FIG. 5, the bracket 20 may also be extendedly provided in the vehicle width direction and can be formed into various forms associated with positional relationships between the bottom 5b and the vehicle body VB.

What is claimed is:

1. An attachment structure of a guide frame in a sunroof apparatus including a roof panel loaded at an opening of a fixed roof of a vehicle; a slider which is attached to the roof panel, slides in a vehicle front-to-rear direction, and opens and closes the roof panel in the vehicle front-to-rear direction; and the guide frame having a guide frame rail for guiding the slider to slide on the guide frame rail, the attachment structure comprising:
a joining member configured to join the guide frame and a vehicle body and provided in the guide frame rail or on an extension of the guide frame rail.

2. The attachment structure according to claim 1, wherein the joining member has a frame extendedly provided in a vehicle width direction, and the frame is attached to the guide frame rail and the vehicle body.

3. The attachment structure according to claim 1, wherein the joining member has a bracket of which one side is attached to the guide frame rail and of which the other side is attached to the vehicle body.
